(19) United States
(12) Patent Application Publication
(10) Pub. No.: US 2008/0272957 A1
(43) Pub. Date: Nov. 6, 2008

(54) Method and device for determining the relative velocity of objects

(76) Inventor: Thomas Schoeberl, Hildesheim (DE)

Correspondence Address: KENYON & KENYON LLP, ONE BROADWAY, NEW YORK, NY, 10004, US

(21) Appl. No.: 12/148,858

(22) Filed: Apr. 22, 2008

(30) Foreign Application Priority Data
Apr. 23, 2007 (DE) 10 2007 019 426.0
Aug. 10, 2007 (DE) 10 2007 037 864.7

(51) Int. Cl. G01S 13/58

(52) U.S. Cl. 342/109; 342/104

(57) ABSTRACT

A method and a device are provided for determining the relative velocity of objects by using transmitted and received microwave radiation. The transmission signal has a carrier frequency which is increased or decreased in a ramp-like manner, and the transmission signal is additionally modulated using a PN code sequence. The reception signal is mixed using the time-delayed PN code sequence and integrated to form a complex correlation gain. The relative velocity of the objects is determined from the variation over time of the correlation result for the mixed and integrated reception signals, and optionally, the distance of the objects is determined from the time delay of the PN code sequence.

### RELATED APPLICATION INFORMATION

The present application is based on priority German patent application no. 10 2007 019 426.0, which was filed in Germany on Apr. 23, 2007, and based on priority German patent application no. 10 2007 037 864.7, which was filed in Germany on Aug. 10, 2007 the disclosures of which are incorporated herein by reference.

### FIELD OF THE INVENTION

The exemplary embodiments and/or exemplary methods of the present invention relates to a device and a method for determining the relative velocity of objects by using transmitted and received microwave radiation, the transmission signal having a carrier frequency which is increased or decreased in a ramp-like manner, the transmission signal being additionally modulated using a PN code sequence, and the reception signal being mixed using the time-delayed PN code sequence and then integrated. The relative velocity of the objects is determined from the time progression of the correlation result for the mixed and integrated reception signals, and optionally, the distance of the objects is determined from the time delay of the PN code sequence.

### BACKGROUND INFORMATION

A method and a device are discussed in German patent document DE 10 2005 012 945 A1 for measuring the distance and relative velocity of multiple objects using FMCW radar, in which transmission signals having linear ramp slopes over time are emitted, and the reception signals reflected on objects are received and mixed with the transmission signals. A combination of distance and relative velocity values is associated with the mixer output frequencies of each frequency ramp for each object, and the distance and relative velocity of a possible object are determined from intersection points of multiple distance and relative velocity combinations; the possible objects may be apparent objects or real objects as the result of ambiguities. These apparent objects which result from ambiguities are eliminated by randomly modifying the frequency slope of at least one frequency ramp in a subsequent measurement cycle.

A device is discussed in German patent document DE 103 29 569 A1 for detecting objects in a detection range, in which radar pulses are transmitted via a transmission channel, and pulses reflected on the objects are received via a reception channel. For this purpose a delay arrangement is provided in the reception channel via which pulses which are mixed with the reception signals in the receiving branch may be variably delayed with respect to the transmission pulses. In addition, for each delay value of the delay arrangement, pulses having at least two different carrier frequencies are transmitted, the carrier frequencies being a function of the measurement distance and thus of the delay value.

### SUMMARY OF THE INVENTION

An aspect of the exemplary embodiments and/or exemplary methods of the present invention is to provide a radar system in which modulation is performed using a pseudonoise (PN) code, and the degradation of the correlation gain is modified for moving targets, and the masking effect of weak targets in the presence of excessively intensely moving targets is compensated for. Furthermore, determining the time progression of the correlation gain allows a determination of the relative velocity of objects located within a distance to be sampled. This is achieved according to the exemplary embodiments and/or exemplary methods of the present invention by the features described herein. Advantageous refinements and embodiments result from the further disclosures herein.

Advantageously, in the system according to the exemplary embodiments and/or exemplary methods of the present invention, the distance of the objects is determined from the time delay of the PN code sequence of the receiving branch, and the relative velocity of the objects is determined from the time progression of the correlation result of the reception signals mixed with the transmission signal, and from the integration of the output signals of the mixer.

In addition, the integration of the output signals of the mixer for determining the correlation gain is advantageously performed over a time period which corresponds to the time length of a PN code.

It is also advantageous for the time delay of the PN code to be modified in such a way that different distance ranges are successively sampled for objects in a stepwise manner. The distance range d which is to be sampled within a certain time period may thus be held constant, and the objects detected therein may be ascertained on the basis of the correlation result, and relative velocities Vr thereof may be ascertained.

It is particularly advantageous when the time period, within which the time delay of the PN code sequence is constant in order to sample a given distance range, is an integral multiple of the total time period of the PN code sequence. In this manner the constantly repeating PN code sequence may be successively repeated, so that at the start of the measurement in the next distance range the PN code sequence is synchronous with the modification of the distance range to be measured, and starts at the same time.

It is also advantageous to sample the correlation result for a distance range at a sampling frequency fₛₐₘₚₗₑ. The correlation result for a distance range is sampled over a certain number of repeating PN code sequences.

The number of PN code sequences per distance range sampled may be greater than the comparable number of PN code sequences resulting from sampling frequency fₛₐₘₚₗₑ.

Time period Tₛₐₘₚₗₑ during which the output signals are sampled may advantageously be an integral multiple of the time period of a PN code sequence, time period Tₛₐₘₚₗₑ also being shorter than the time period during which a distance range d is sampled and during which time delay τ remains constant.

It is also particularly advantageous to determine sampling frequency fₛₐₘₚₗₑ as a function of a predetermined resolution of measured relative velocity Vr. The previously measured relative velocity Vr may be provided and used as an output variable, so that when high relative velocities Vr are expected which result in larger Doppler frequency shifts, sampling frequency fₛₐₘₚₗₑ may be selected to be smaller than for low relative velocities Vr.

It is also advantageous for the reception signal and the delayed PN code sequence to be sent to an in-phase channel and a quadrature channel, the delayed PN code sequence of the quadrature channel being rotated by 90° with respect to the delayed PN code sequence of the in-phase channel, and the mixing, integration, and determination of the correlation gain being performed separately in each channel. In this manner, masking as the result of the phase position of the signal components may be prevented, and on the basis of the two mutually orthogonal signals a real component and an imaginary component may be determined for the correlation gain.

It is also advantageous that from the correlation results for the in-phase channel and the quadrature channel a complex correlation gain is determined for each distance range. The time sequence of the complex correlation gain may be transformed into the frequency range using a Fourier transformation. By computation of the complex correlation gain it is also possible to analyze the complex phase of the correlation gain in the frequency range, and from the phase progression to determine relative velocities Vr for each detected object. It is particularly advantageous that in each case an object and its relative velocity Vr may be associated with each maximum of the Fourier-transformed frequency spectrum. It is also advantageous that relative velocity Vr of the detected object is determined from the progression of the phase between the correlation gain for the in-phase channel and the correlation gain for the quadrature channel.

It is also advantageous that the measurement time is shortened by parallelization of the mixer and the integrators, and thus by the parallel determination of the correlation result for multiple distances.

It is also advantageous that the individual PN codes of the various distance ranges are internested for multiple integrations as a function of the length of the PN code and sampling frequency fₛₐₘₚₗₑ, and therefore multiple correlation results may be computed simultaneously in the in-phase channel and in the quadrature channel with the aid of each integrator, thus reducing the complexity of hardware and also decreasing the measurement time for computing the correlation.

Exemplary embodiments of the present invention are explained below with reference to the drawings.

### BRIEF DESCRIPTION OF THE DRAWINGS

FIG. 1 shows a block diagram of one embodiment of the device according to the present invention.

FIG. 2 shows a block diagram of a further embodiment of the device according to the present invention.

FIG. 3 shows an embodiment of one possible frequency-time diagram of the source signal f_{q}, which may be used for generating the transmission signals of the device according to the present invention corresponding to FIG. 1 or 2.

FIG. 4 shows a graphic illustration of the PN code sequences and distance ranges d to be sampled over time.

FIG. 5 shows a graphic illustration of the PN code sequences and distance ranges d to be sampled over time, for a sequential internesting of the codes.

FIG. 6 shows a graphic illustration of the PN code sequences and distance ranges d to be sampled over time, for parallel and synchronous nesting of the code sequences.

FIG. 7 shows a graphic illustration of the PN code sequences and distance ranges d to be sampled over time, for parallel and nonsynchronous nesting of the code sequences.

### DETAILED DESCRIPTION

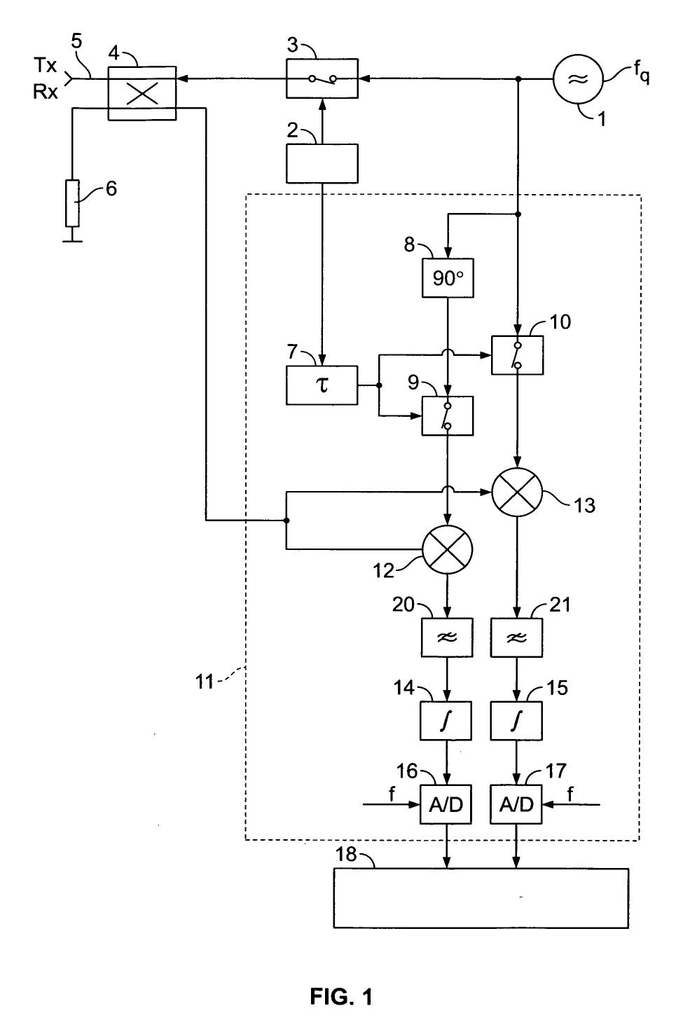

FIG. 1 illustrates one exemplary embodiment of the device according to the present invention, showing a high-frequency source 1 which generates a source signal f_{q}, which increases linearly over time in a ramp-like manner, for example, from a lower threshold frequency fᵤ to an upper threshold frequency fₒ. The ramp slope is held constant during the measurement of a distance range, advantageously during the measurement of all distance ranges.

The output signal from this high-frequency source 1 is sent to a transmission channel modulator 3 and is also branched for the reception channel. A PN code generator 2 is also provided which generates a pseudonoise (PN) code which has a certain duration and is continuously repeated. This PN code of PN code generator 2 is sent to transmission channel modulator 3, in which a switch opens and closes in the pattern of the generated PN code, as the result of which PN modulation is imparted to source signal f_{q} in addition to the FMCW modulation. This PN-modulated FMCW signal from transmission channel modulator 3 is sent to a transmit/receive switch 4 which relays transmission signal Tx to an antenna 5 which emits transmission signal Tx.

Since the device according to the present invention may be used in a motor vehicle, for example, and may be used to detect vehicles passing by and stationary objects on the edge of the roadway, in this case transmission signal Tx is advantageously emitted in the region in front of the vehicle and is reflected on objects within this detection range. The reflected signals are reflected back as reception signals Rx, and are likewise received by transmit/receive antenna 5. Of course, transmission signals Tx and reception signals Rx may also be transmitted and received by a separate transmission antenna and reception antenna, respectively. In this case of a bistatic transmission and reception system, the duplexer is omitted, in comparison to the design as a monostatic system, which in the present exemplary embodiment is implemented by transmit/receive switch 4.

Since on account of relative velocity Vr of the detected objects the signals which are transmitted and received back experience a Doppler shift, and also for the duration of the propagation time of these signals transmission frequency f_{q} is continuously varied, reception signal Rx experiences a frequency shift with respect to transmission signal Tx which is caused by both the FMCW modulation and the Doppler shift. In addition, the PN code sequence of received signal Rx is shifted with respect to the PN code sequence of transmitted signal Tx, which is likewise caused by the propagation time of the signal from the antenna to the detected object and back to the antenna. Reception signal Rx is relayed by transmit/receive switch 4 to a reception channel, it being possible to use a line coupler, for example, as a transmit/receive switch 4, the line coupler being terminated at its fourth output by a suitable surge impedance, using a terminating resistor 6. The reception signal emitted by transmit/receive switch 4 is split into two signals, the first channel being referred to as the in-phase channel and the second channel being referred to as the quadrature channel. In each of these two channels reception signal Rx is sent to a mixer 12, 13.

The signal branched from high-frequency source 1 is split once again, this signal being sent to a first reception channel modulator 10 for the in-phase channel, and the second branch being sent to a phase shifter 8 which rotates the FMCW-modulated high-frequency signal by a phase angle of 90° and sends the signal to a second reception channel modulator 9 which is designated for the quadrature channel. First reception channel modulator 10 and second reception channel modulator 9 are activated via a time-delayed PN code sequence. The PN code of PN code generator 2 sent to transmission channel modulator 3 being fed, for this purpose to a delay circuit 7 which delays the PN code by time period τ, time period τ corresponding to the signal propagation time required by transmission signal Tx to travel from transmission antenna 5 to the reflecting object in distance range d being sampled at the moment, and back to reception antenna 5.

The PN code signal delayed by delay unit 7 is sent to first reception channel modulator 10 and to second reception channel modulator 9, which likewise PN-modulates the transmission signal branched for the reception. The output signals from first reception channel modulator 10 are sent to first reception mixer 13 of the in-phase channel, and the output signal from second reception channel modulator 9 is sent to second reception mixer 12 in the quadrature channel. The transmission signals modulated using the delayed PN code sequence and phase-shifted for the quadrature channel are mixed with reception signal Rx in reception mixers 12, 13, resulting in intermediate frequency signals which are subsequently processed. After the in-phase signal and the quadrature signal are demodulated in mixers 12, 13, each mixer output signal is filtered in a low-pass filter 20, 21 in order to mask nonrelevant frequency spectra. After low-pass filtering in blocks 20, 21, a separate integrator 14, 15 is provided for each of the two reception channels which integrate the mixer output signals from reception mixers 12, 13, and the signals are subsequently converted to digital signals via A/D converters 16, 17 and then sent to an evaluation unit 18. In each case a delay time period τ is set in delay unit 7 for sampling distance ranges d which are located at different distances. The downstream integrators compute a correlation of the reception signals, from which the correlation gain may be derived for each detected object in the corresponding distance range.

A/D converters 16, 17 are operated at a sampling frequency fₛₐₘₚₗₑ, which corresponds to the respective expected relative velocity Vr of the detected objects, in order to achieve the intended resolution with regard to relative velocity Vr. This sampling frequency fₛₐₘₚₗₑ may have been determined, for example, by evaluation unit 18 in the previous detection cycle, and provided by same. If the code of the received signal agrees with the reference code of reception channel modulators 9, 10 with respect to time, which is achieved by setting delay τ in delay unit 7, on account of the autocorrelation characteristics of the PN sequence the correlation gain is maximized, or otherwise is minimized. The distance of the target objects may be determined when a maximum of the correlation gain is detected, using the temporal shift of the PN code and information concerning the reference code of reception channel modulators 9, 10. For two targets at different distances, the ratio of the minimum correlation gain of one target to the maximum correlation gain of the other target corresponds to the detection capability of the radar sensor. For moving targets, the rotation of the phase between reception signal Rx and the reference signal from reception channel modulators 9, 10 as a result of the Doppler frequency and the linear change over time of source frequency f_{q} causes degradation of the maximum and minimum correlation gain. The maximum correlation gain is decreased, and the minimum correlation gain for the moving object is increased. This also results in masking effects so that, despite maximum correlation gain, a weak target is masked by a strongly received moving target at another distance, and, therefore, a poor minimum correlation gain. The degradation of the ratio between minimum and maximum correlation gains increases with increasing velocity Vr and for large ramp slopes.

The result of the integration in integrators 14, 15 represents a complex correlation gain. Due to IQ decomposition, the correlation gain is independent of the random phase position between reception signal Rx and the reference signal from reception channel modulators 9, 10. The absolute value of the correlation gain in turn is a measure of the detection of an individual target in sampled distance range d, and is a function of time delay τ of the reference PN code. To determine the velocity of all targets in a distance range, integrators 14, 15 are read out over time at sampling frequency fₛₐₘₚₗₑ and a sampling number N, the time-delayed PN code being delayed by τ corresponding to this distance range d. The N sampling values may then be transformed into the frequency range, using a Fourier transformation. Each peak in the frequency range which does not result from a strong moving target at another distance as the result of the minimum correlation gain represents a target in this distance range d, the frequency peak being more or less pronounced depending on relative velocity Vr.

The circuit elements delineated by the dashed line represent a reception channel composed of an in-phase channel and a quadrature channel. A reception channel of this type is able to sample only one distance range for objects within a given time period.

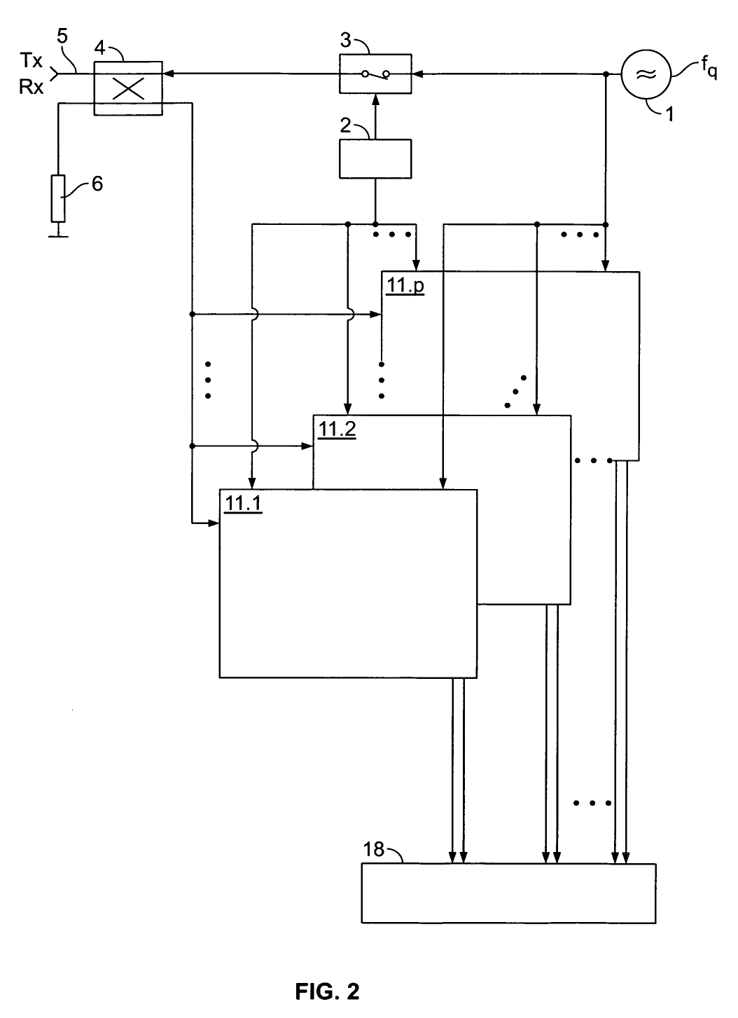

FIG. 2 illustrates a further embodiment of the device according to the present invention, in which multiple distance ranges may be simultaneously sampled due to the fact that reception channel 11, illustrated in FIG. 1, is provided multiple times in parallel, and the PN codes of code generator 2 and associated delay periods τ of delay element 7 are internested, as described in greater detail below. For this purpose, high-frequency source 1 is shown as illustrated and described in FIG. 1, and sends an FMCW-modulated signal to a transmission channel modulator 3 and likewise branches off for the reception channel. Also provided, as described with reference to FIG. 1, are a PN code generator 2, a transmit/receive switch 4, and an antenna 5, which is designed as a monostatic radar system. Of course, in this case the system according to the exemplary embodiments and/or exemplary methods of the present invention may alternatively be designed as a bistatic radar system having separate antennas for transmission and reception.

Also illustrated are n reception channels 11.1, 11.2 through 11.p connected in parallel, each of which has an in-phase channel and a quadrature channel, as illustrated in FIG. 1 within reception channel 11. The reception signal from duplexer 4 is sent to each of reception channels 11.1, 11.2 through 11.p, FMCW-modulated high-frequency signal f_{q} from signal source 1 and the PN code of PN code generator 2 likewise being sent. Each of reception channels 11.1, 11.2 through 11.p, as described for FIG. 1, in each case generates an in-phase output signal and a quadrature output signal, each of which is sent to evaluation unit 18. Each of reception channels 11.1, 11.2 through 11.p is responsible for the detection and evaluation of reception signals Rx for a distance range. Thus, up to p distance ranges may be simultaneously evaluated. Furthermore, multiple distance ranges (for example, six distance ranges d1 through d6) may also be measured by evaluating only some of the distance ranges in parallel (for example, three distance ranges d1 through d3 with the aid of three reception channels 11.1, 11.2, 11.3), and in the next measurement cycle another portion of the distance ranges is then evaluated using the same reception channels (for example, three distance ranges d4 through d6 with the aid of three reception channels 11.1, 11.2, 11.3). This results in much quicker evaluation of the objects present in the detection ranges. The corresponding method is explained in greater detail below with reference to FIG. 4.

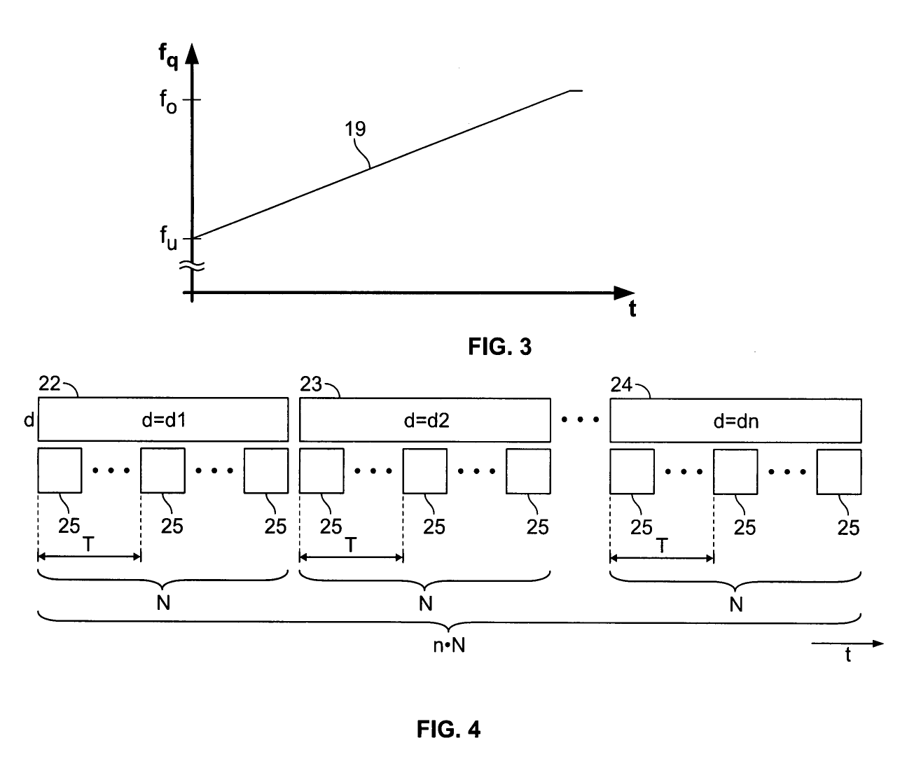

FIG. 3 illustrates a frequency-time diagram showing the FMCW modulation of high-frequency source 1 as an example. A source frequency f_{q} is illustrated which increases linearly over time from a lower threshold frequency fᵤ to an upper threshold frequency fₒ, which is represented by ascending frequency ramp 19. This ramp-shaped ascending frequency pattern is then repeated. The slope of the frequency ramp may be changed, but this change in the ramp slope is advantageously not performed until after a measuring pass has gone through all distance ranges to be sampled. Alternatively, instead of a ramp-shaped ascending frequency modulation, a ramp-shaped descending frequency modulation may be performed. It is also possible to alternate ascending and descending frequency ramps.

FIG. 4 illustrates the procedure for modifying the system parameters over time t, distance d being illustrated in the top row. Thus, distance range d=d1 is sampled for objects for the time period of block 22 by setting delay time τ of delay unit 7 corresponding to the signal propagation time for reflection on objects in distance range d=d1. During this time PN code 25 is repeated multiple times, the time period of the samples of the integration resulting from integrators 14, 15 extending over only a portion of the PN code duration by use of sampling frequency fₛₐₘₚₗₑ, which in the drawing is illustrated by duration Tₛₐₘₚₗₑ. Thus, N samples are performed during the measurement time period for distance range d=d1, via which the variation over time of the correlation gain for the reception signals is determined. The same procedure is then repeated, except that in block 23, distance range d has been shifted to next distance range d=d2 by modifying delay value τ. This procedure is repeated for the individual distance ranges until the last distance range d=dn, represented by block 24, has been sampled. This is followed by a repetition of sampling for the distance ranges in which time delay τ is reset corresponding to distance range d=d1. First, for a fixed distance d the complex correlation gain is sampled using a sampling number N and at sampling rate fₛₐₘₚₗₑ. For next distance d the correlation gain is then measured using a sampling number N. By repeatedly measuring the complex correlation gain at a fixed sampling rate fₛₐₘₚₗₑ and sampling number N, the velocity of the detected object may be determined from the variation of the values within a phase of the correlation gain.

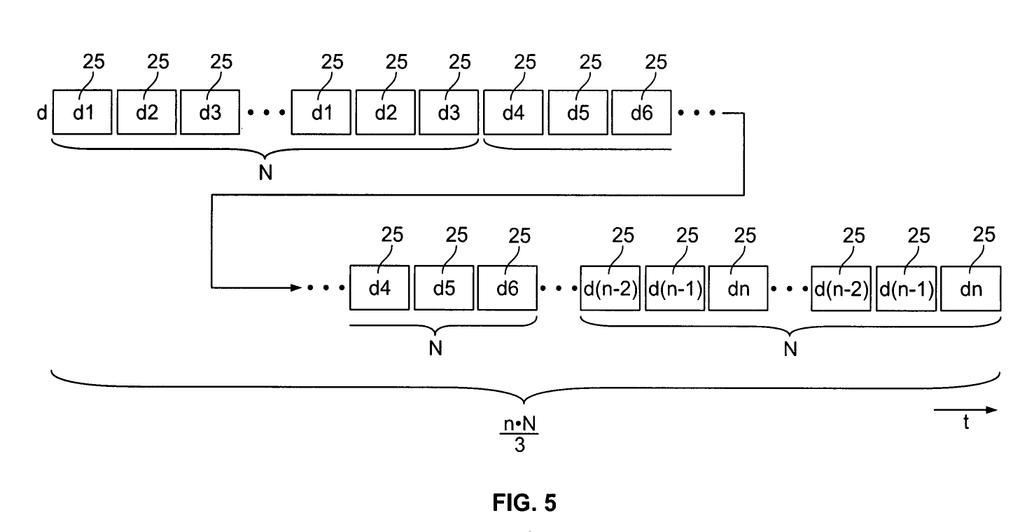

FIG. 5 illustrates the internesting of measurements of different distance ranges, as may be performed using the device according to FIG. 1. It is shown that successive codes are generated for the distance ranges to be sequentially measured; in the illustrated example where n=1 reception channels, these are reception ranges d1 through d3. These ranges d1 through d3 are repeated N times, and the other reception ranges d=d4 through d6 are then sampled. These distance ranges d4 through d6 are likewise successively repeated N times in a sequential manner over time. This pattern is continued until nth distance range d has been sampled. As a result, n·N sampling values are determined. The duration of the measurement is shortened to (n·N)/3.

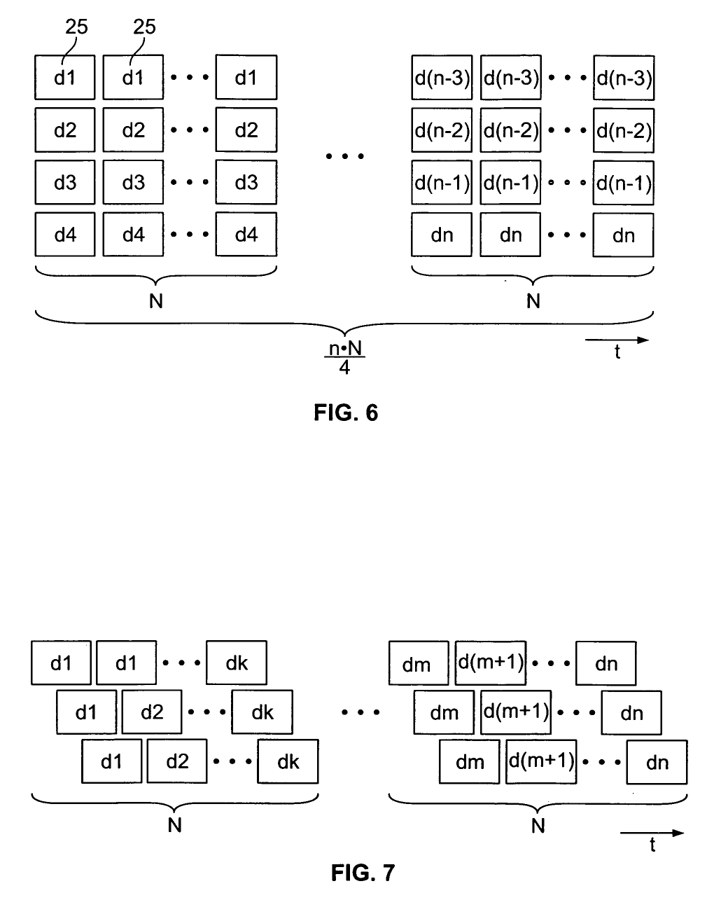

FIG. 6 shows a graphic illustration of the code sequences for a multichannel parallel evaluation, which may be performed, for example, using the device according to FIG. 2. Once again code sequences 25 have been plotted over time, in this example four channels 11.1 through 11.4 being provided in the receiver. The first four distance ranges d=d1 through d4 are transmitted in succession N times, using the generated code sequences, each channel successively sending the same code sequence N times. Then the next four distance ranges are always sampled until distance range d=dn has likewise been sampled N times. In a complete cycle n different distance ranges have thus been sampled N times, a time period of (n·N)/4 code sequences resulting from the four channels. These code sequences are evaluated in parallel in the p reception channels, i.e., in parallel in channels 11.1, 11.2, and 11.3, for example, by sending to each reception channel the corresponding PN codes and the particular propagation time delay τ=τ1 through τ3. These codes and measurement distances may be repeated multiple times, for example N times, the integrators continuously performing sums in each channel. The other distance ranges d=d4 through d6 are then evaluated in parallel by once again sending the corresponding PN codes and the particular propagation time delay τ=τ4 through τ6 to reception channels 11.1, 11.2, and 11.3, thereby evaluating these distance ranges, the measurements also being repeated N times in the particular distance ranges. The number of reception channels 11.p may be increased up to the number of distance ranges p, in which case all distance ranges are evaluated in parallel.

FIG. 7 illustrates a further variant of the code system in which sequential internesting according to FIG. 5 and parallel processing according to FIG. 6 are combined together, and in addition a nonsynchronous sequence of the code sequences is provided in the multiple channels, so that although each channel transmits the same pattern of code sequences 25 over time, these code sequences are offset by a certain time shift.

What is claimed is:

1. A method for determining a relative velocity of objects by using transmitted and received microwave radiation, the method comprising:
one of increasing and decreasing a transmission signal having a carrier frequency in a ramp-like manner;
modulating the transmission signal using a PN code sequence to provide a time-delayed PN code sequence;
mixing and integrating a reception signal using the time-delayed PN code sequence to form a complex correlation gain; and
determining the relative velocity of the objects from a variation over time of the correlation for the mixed and integrated reception signal.

2. The method of claim 1, wherein a distance of the objects is also determined by determining the distance of the objects using a time delay of a received PN code sequence with respect to a transmitted PN code sequence.

3. The method of claim 1, wherein a time delay of the PN code is modified so that different distance ranges are successively sampled for the objects in a step-wise manner.

4. The method of claim 1, wherein the correlation for a distance range is sampled at a sampling frequency.

5. The method of claim 4, wherein the sampling frequency is determined as a function of a maximum Doppler frequency shift resulting from the relative velocity of the objects, an absolute velocity, the distance of the objects, and a ramp slope of an FMCW signal.

6. The method of claim 1, wherein the reception signal and the delayed PN code sequence are sent to an in-phase channel and a quadrature channel, the delayed PN code sequence of the quadrature channel being rotated by 90° with respect to the delayed PN code sequence of the in-phase channel, and a mixing, integration, and determination of the correlation gain being performed separately in each channel.

7. The method of claim 6, further comprising:
determining a complex correlation gain from correlation results of the in-phase channel and the quadrature channel of each distance range, and transforming the complex correlation gain into a frequency range using a Fourier transformation.

8. The method of claim 7, wherein in each case, an object and its relative velocity are associatable with each maximum of the Fourier-transformed frequency spectrum.

9. The method of claim 1, wherein the relative velocity of the detected vehicle is determined from the variation of the phase of the correlation gain for the in-phase channel and of the correlation gain for the quadrature channel.

10. The method of claim 1, wherein there are multiple reception channels which are in parallel, wherein each reception channel is for evaluating a distance range, so as to allow objects in multiple distance ranges to be simultaneously detected and evaluated in parallel.

11. The method of claim 10, wherein the PN codes of the reception channels evaluated in parallel for the various distance ranges are repeated multiple times in succession, and wherein each reception channel is integrated over all PN codes of the reception range to be evaluated by it.

12. A device for determining a relative velocity of objects by using transmitted and received microwave radiation, comprising:
a carrier frequency generating arrangement to generate a carrier frequency which is increased and decreased in its frequency in a ramp-like manner;
a PN code sequence generating arrangement to generate a PN code sequence via which the transmission signal and the reception signal are also PN-modulated;
a delay arrangement to delay the reception signal which is PN-modulated and modulated in a ramp-like manner; and
at least one mixing and integrating arrangement to mix the reception signal with the time-delayed transmission signal and subsequently integrate it to determine a correlation gain;
wherein the relative velocity of the objects is determined from a variation over time of the correlation result of the mixed and integrated reception signals.

13. The device of claim 12, further comprising:
a determining arrangement to determine the distance of the objects, where the distance of the objects is determined from the time delay of the received PN code sequence with respect to the transmitted PN code sequence.

14. The device of claim 12, wherein the device has an in-phase channel and a quadrature channel for processing the reception signal, and wherein an evaluation unit determines phases of the in-phase channel signal and of the quadrature channel signal, and determines, from the variation thereof, the relative velocity of the detected objects.
